(19) United States
(12) Patent Application Publication
(10) Pub. No.: US 2014/0218847 A1
(43) Pub. Date: Aug. 7, 2014

(54) ELECTRONIC DEVICE WITH DISPLAY

(71) Applicant: HON HAI PRECISION INDUSTRY CO., LTD., New Taipei (TW)

(72) Inventors: Tay-Yang LIN, New Taipei (TW); Chin-Feng CHEN, New Taipei (TW); Chia-Jung LIU, New Taipei (TW); Yi-Ru LAI, New Taipei (TW)

(73) Assignee: HON HAI PRECISION INDUSTRY CO., LTD., New Taipei (TW)

(21) Appl. No.: 14/138,127

(22) Filed: Dec. 23, 2013

(30) Foreign Application Priority Data
Feb. 4, 2013 (TW) 102104144

(51) Int. Cl. G06F 1/16

(52) U.S. Cl. CPC G06F 1/1681
USPC 361/679.01

(57) ABSTRACT

An electronic device includes a base, a display and a rotating member. The rotating member includes a rotating portion and an installation portion. The rotating portion is rotatably mounted to the base. An installation shaft is secured to the installation portion. The display is rotatable relative to the rotating member about the installation shaft. The rotating member is rotatable relative to the base between a first position and a second position. When the rotating member is in the first position, the installation shaft is above the base, and the display is rotatable from an initial position to a first open position. When the rotating member is in the second position, the installation shaft is below the base, and the display is rotatable from the first open position to a second open position. The display rotates 360 degrees from the initial position to the second open position.

### BACKGROUND

1. Technical Field

The present disclosure relates to electronic devices, and particularly to an electronic device with a display.

2. Description of Related Art

An electronic device with a display, such as a notebook, have a display rotatably mounted to a base by a complicated rotating assembly. However, a rotating angle between the display and the base is generally smaller than 180 degrees, and the display cannot be rotated 360 degrees. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of an electronic device.

FIG. 2 is an enlarged view of a circled portion II of the electronic device of FIG. 1.

FIG. 3 is an enlarged view of a circled portion III of the electronic device of FIG. 1.

FIG. 4 is an assembled, isometric view of the electronic device of FIG. 1 without a cover.

FIG. 5 is an assembled, isometric view of the electronic device of FIG. 1.

FIG. 6 is an assembled, schematic view of the electronic device of FIG. 1, showing a rotating member in a first position and a display in an initial position.

FIG. 7 is an assembled, schematic view of the electronic device of FIG. 1, showing the rotating member in the first position and the display in a first open position.

FIG. 8 is similar to FIG. 7, but shows the rotating member in a second position and the display in a second open position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

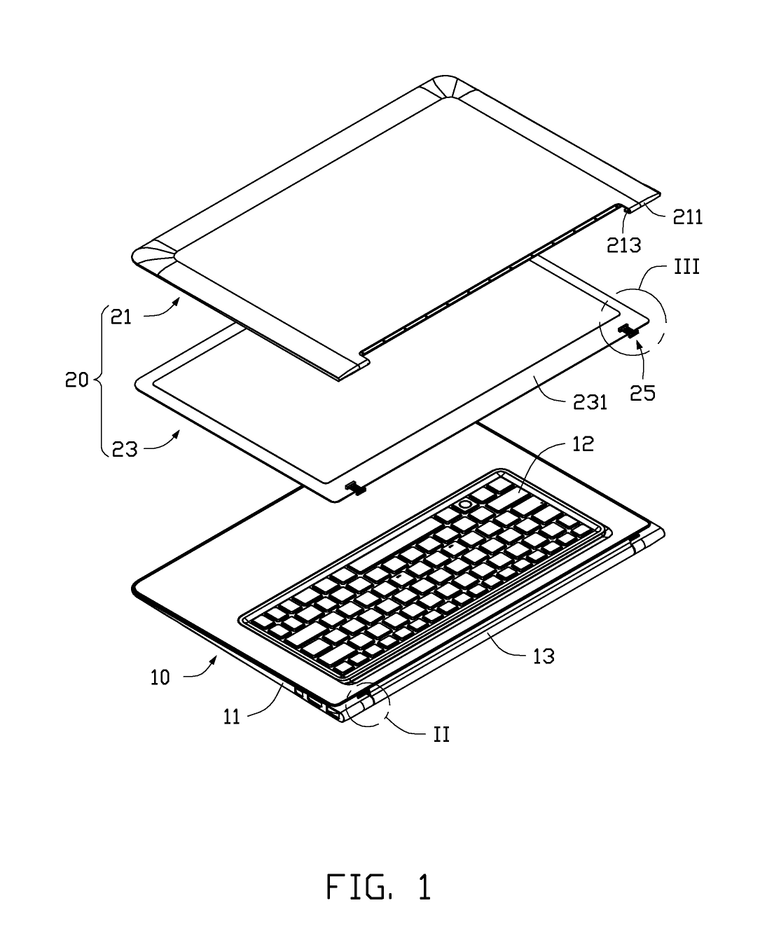

FIG. 1 shows one embodiment of an electronic device. The electronic device comprises a base 10 and a display 20 capable of being rotatably mounted to a side of the base 10.

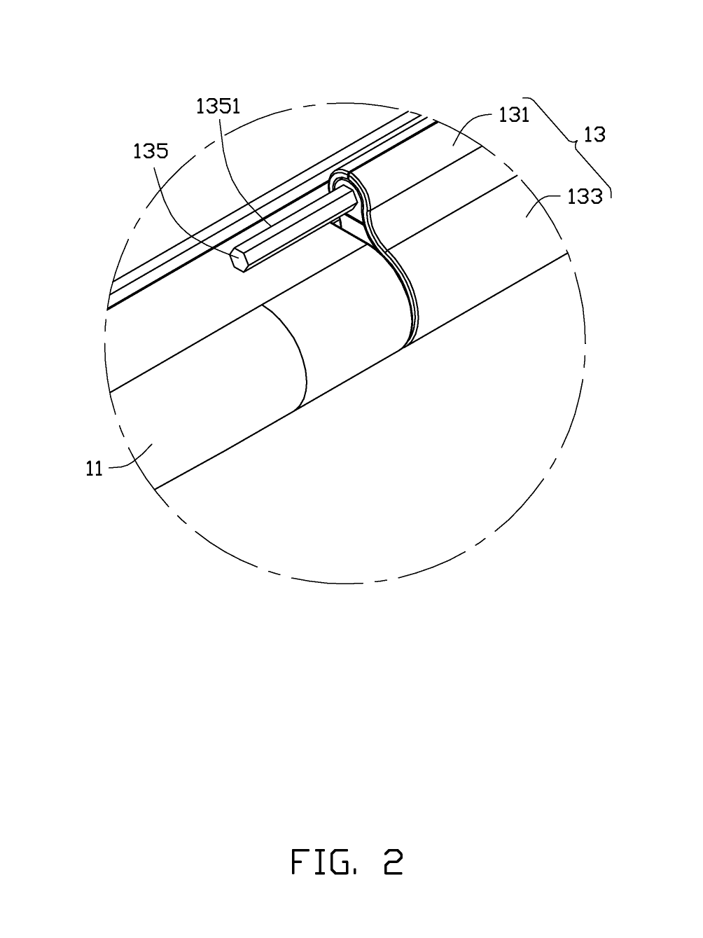

FIG. 2 shows that the base 10 comprises a bottom plate 11, a keyboard 12 located on the bottom plate 11, and a rotating member 13 rotatably mounted to a side of the bottom plate 11. The rotating member 13 comprises an installation portion 131 and a rotating portion 133. The rotating member 13 is rotatably mounted to the bottom plate 11 through a rotating shaft (not shown). An installation shaft 135 is secured to each of opposite ends of the installation portion 131. The rotating shaft is substantially parallel to the installation shaft 135.

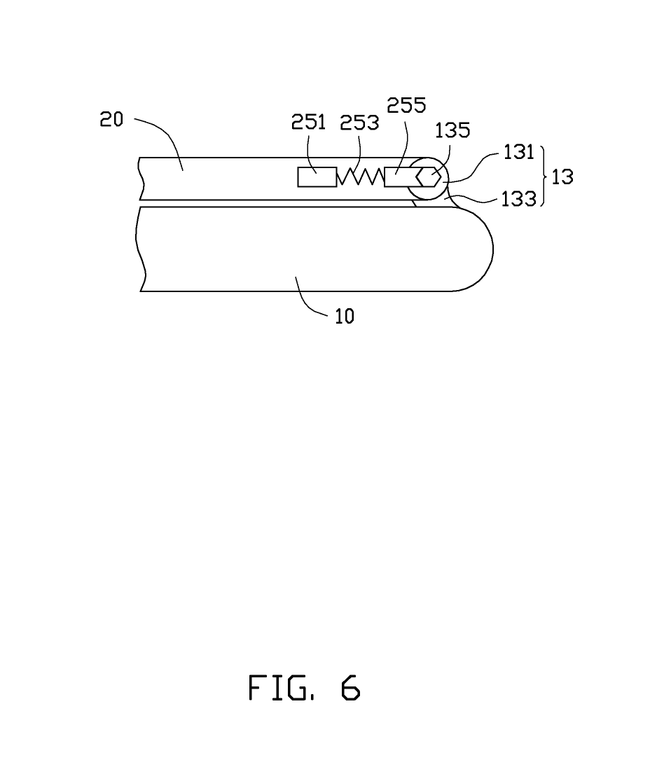

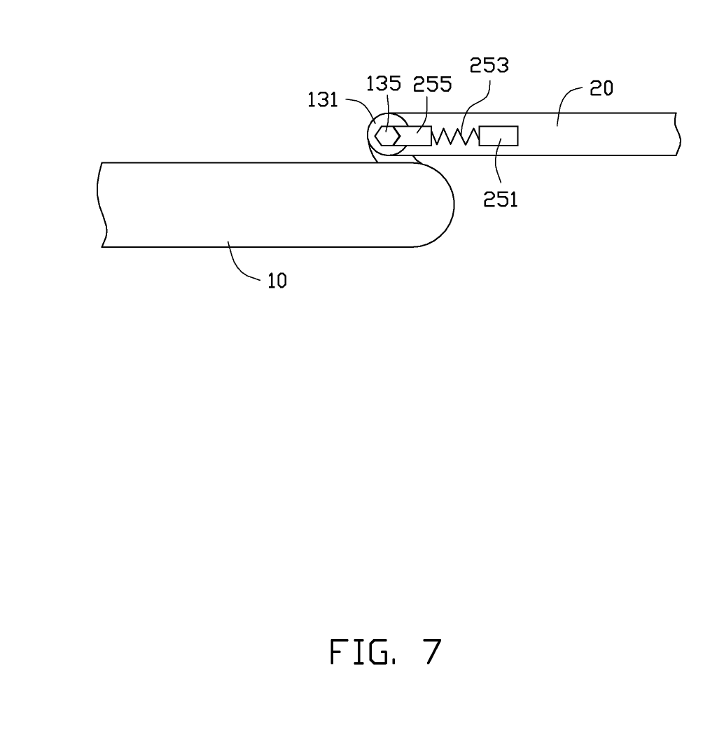

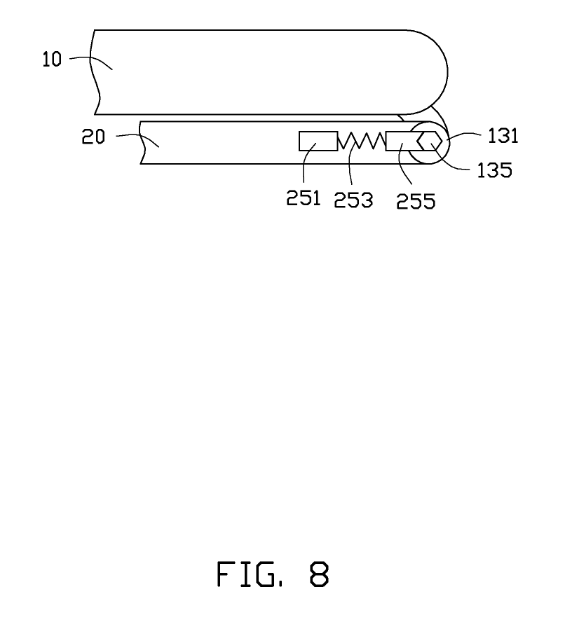

FIGS. 6-8 show that the rotating portion 133 is rotatable relative to the bottom plate 11 between a first position and a second position about the rotating shaft. When the rotating portion 133 is in the first position, the installation portion 131 is above the bottom plate 11. When the rotating portion 133 is in the second position, the installation portion 131 is below the bottom plate 11. In one embodiment, a cross section of each of the installation portion 131 and the rotating portion 133 is circular, and a diagram of the rotating portion 133 is greater than that of the installation portion 131. In one embodiment, the installation shaft 135 is a regular prism, and the installation shaft 135 is a regular hexagonal prism. The installation shaft 135 comprises a plurality of corners 1351, which is defined by each adjacent two side surfaces. In one embodiment, a cross section of the rotating member 13 is substantially pear-shaped.

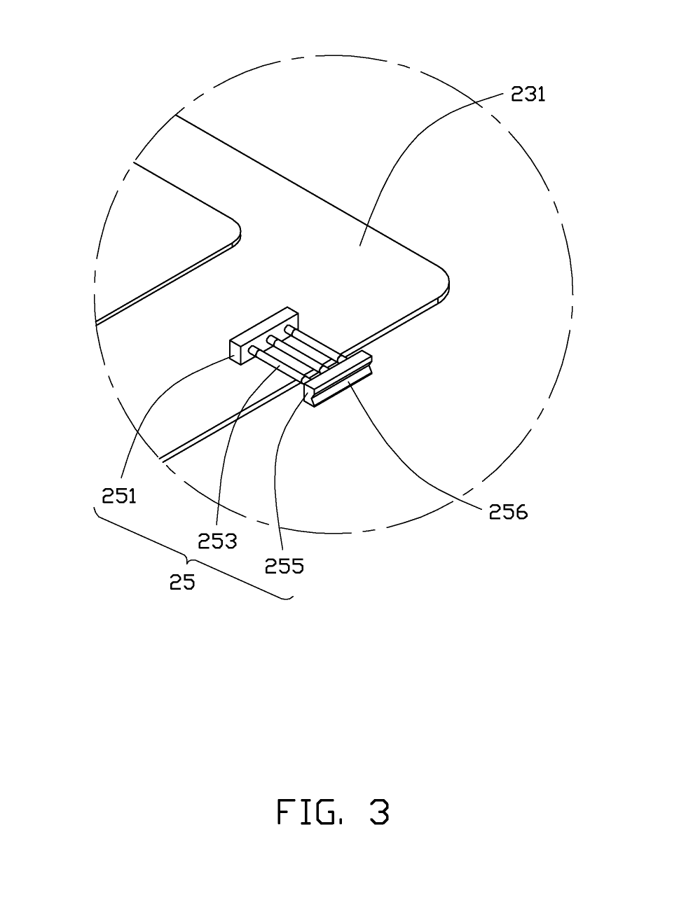

FIG. 3 shows that the display 20 comprises a cover 21 and a screen 23 capable of being secured to the cover 21. The cover 21 comprises a pivoting portion 211, which defines a pivoting shaft 213. The screen 231 comprises a screen panel 231.

A latching assembly 25 is secured to the screen panel 231. The latching assembly 25 comprises a mounting member 251, a resilient member 253, and a latching member 255. The mounting member 251 is secured to the screen panel 231. A first end of the resilient member 253 is secured to the mounting member 251, and a second end of the resilient member 253 is secured to the latching member 255. The latching member 255 defines a recessed slot 256. The latching member 255 extends out of the screen panel 231. In one embodiment, the resilient member 253 is a compression spring, the recessed slot 256 is triangle. An angle of the recessed slot 256 is substantially equal to an angle of each corner 1351.

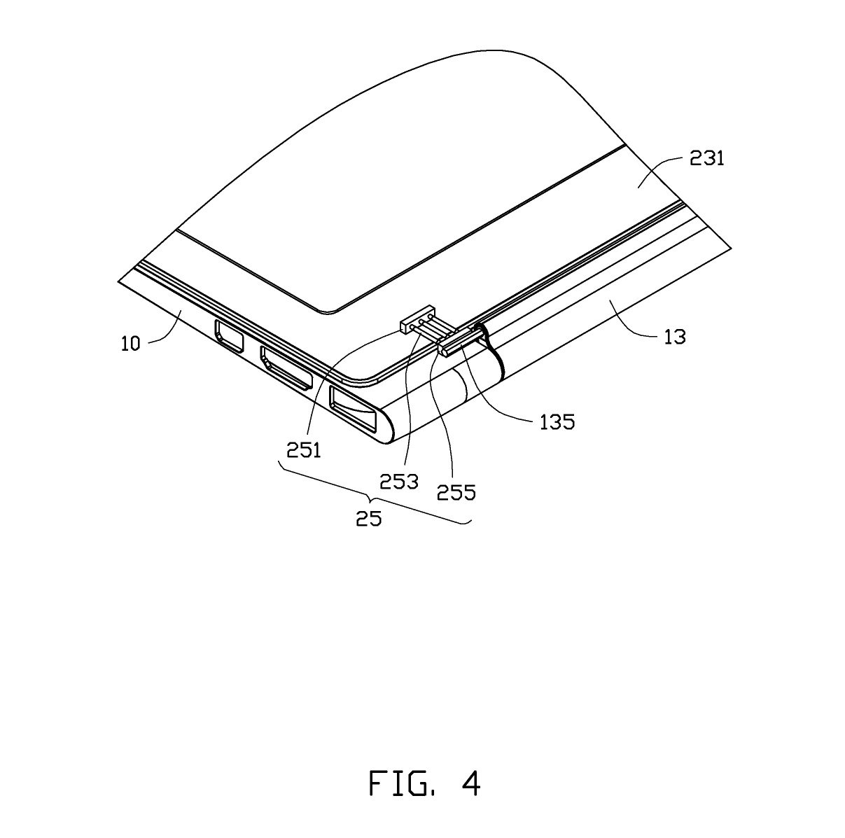

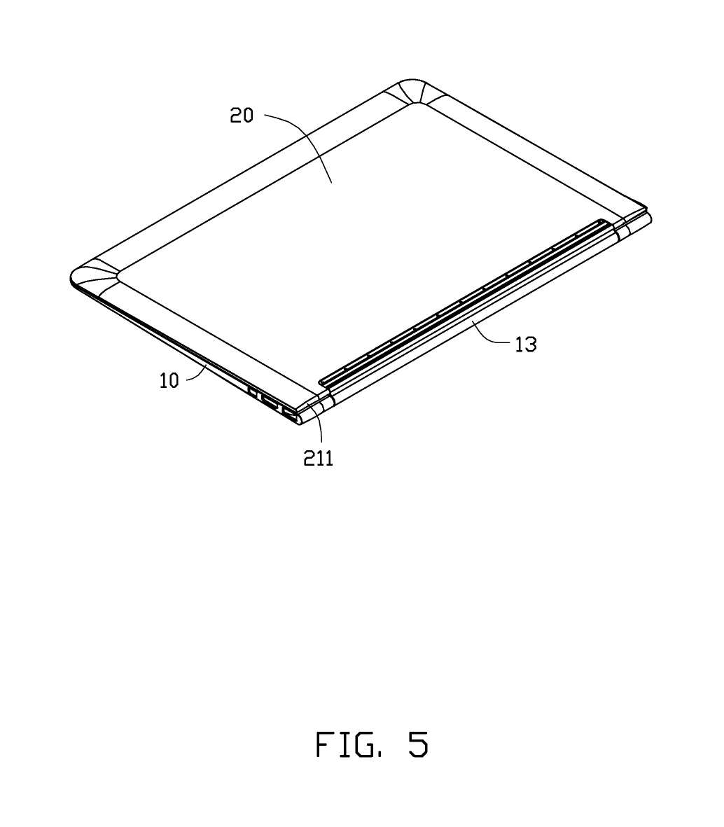

FIG. 4 and FIG. 5 show that, in assembly, the screen 23 is adhered to the cover 21 or secured to the cover 21 by other securing methods. The pivoting portion 211 covers the latching assembly 25. The display 20 is installed to the base 10 with the installation shaft 135 received in the pivoting slot 213 and one of the plurality of corners 1351 engaged in the recessed slot 256. The display 20 is rotatable about the installation shaft 135. In this position, the display 20 covers the base 10 and is substantially parallel to the base 10, the display 20 is located in an initial position, and the rotating portion 133 is located in the first position.

FIGS. 6-8 show that, the display 20 being rotated about the installation shaft 135. When the display 20 is rotated, the display 20 rotates the latching member 255 about the installation shaft 135, the corner 1351 presses an inner surface of the recessed slot 256 to elastically deform the resilient member 252. When the adjacent corner 1351 is aligned with the installation slot 135, the resilient member 253 rebounds to engage the adjacent corner 1351 in the recessed slot 256. Thus, the display 20 can be rotated to a suitable position until the display 20 is blocked to the base 10. In this position, the display 20 is located in a first open position. The display 20 rotates 180 degrees relative to the initial position and is substantially parallel to the base 10.

When the display 20 is in the first open position, the display 20 is further rotated, rotating the rotating member 13 under momentum, until the rotating portion 133 is in the second position. The installation portion 131 is located below the bottom plate 11. The display 20 can be further rotated 180 degrees about the installation shaft 135 to be located below the base 10. The display 20 is located in a second open position and substantially parallel to the base 10. The display 20 rotates 360 degrees from the initial position to the second open position.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. An electronic device, comprising:
a base;
a display;
a rotating member comprising a rotating portion and an installation portion connected to the rotating portion; and
an installation shaft secured to the installation portion;
wherein the rotating portion is rotatably mounted to the base; the display is rotatable relative to the rotating member about the installation shaft; the rotating member is rotatable relative to the base between a first position and a second position; when the rotating member is in the first position, the installation shaft is above the base, and the display is rotatable from an initial position to a first open position; and when the rotating member is in the second position, the installation shaft is below the base, and the display is rotatable from the first open position to a second open position.

2. The electronic device of claim 1, wherein a rotating angle between the initial position and the second opening position is in a range of 0-360 degrees.

3. The electronic device of claim 1, further comprising a latching assembly, wherein the latching assembly is resiliently mounted to the display and latched to the installation shaft.

4. The electronic device of claim 3, wherein when the display is rotated about the rotating member, the installation shaft elastically deform the latching assembly, and when the display stops rotating, the latching assembly rebounds to engage with the installation shaft.

5. The electronic device of claim 3, wherein the latching assembly comprises a latching member, a mounting member, and a resilient member; the mounting member is mounted to the display; a first end of the resilient member is secured to the mounting member, and a second end of the resilient member is secured to the mounting member; and the latching member is resiliently engaged with the installation shaft.

6. The electronic device of claim 5, wherein the display comprise a cover and a screen secured to the cover; the screen comprises a screen panel; the mounting member is secured to the screen panel; the cover comprises a pivoting portion, and the pivoting portion defines a pivoting slot; and the installation shaft is received in the pivoting slot.

7. The electronic device of claim 5, wherein the installation shaft is a regular prism.

8. The electronic device of claim 7, wherein the installation shaft comprises a plurality of side surfaces, and a corner is defined by each adjacent two of the side surfaces; and the latching member defines a recessed slot configured for latching the corner.

9. The electronic device of claim 8, wherein when the display is rotated from the initial portion to the second position, the corner is engaged in the recessed slot one by one.

10. The electronic device of claim 1, wherein a cross section of the rotating member is pear-shaped.

11. An electronic device, comprising:
a base;
a display;
a rotating member comprising a rotating portion and an installation portion connected to the rotating portion; and
an installation shaft secured to the installation portion;
wherein the rotating portion is rotatably mounted to the base through a rotating shaft; the display is rotatable relative to the rotating member about the installation shaft; the rotating member is rotatable relative to the base about the rotating shaft; and the installation shaft is substantially parallel to the rotating shaft.

12. The electronic device of claim 11, wherein the rotating member is rotatable relative to the base between a first position and a second position; when the rotating member is in the first position, the installation shaft is above the base, and the display is rotatable from an initial position to a first open position; and when the rotating member is in the second position, the installation shaft is below the base, and the display is rotatable from the first open position to a second open position.

13. The electronic device of claim 12, wherein a rotating angle between the initial position and the second opening position is in a range of 0-360 degrees.

14. The electronic device of claim 11, further comprising a latching assembly, wherein the latching assembly is resiliently mounted to the display and latched to the installation shaft.

15. The electronic device of claim 14, wherein when the display is rotated about the rotating member, the installation shaft elastically deform the latching assembly, and when the display stops rotating, the latching assembly rebounds to engage with the installation shaft.

16. The electronic device of claim 14, wherein the latching assembly comprises a latching member, a mounting member, and a resilient member; the mounting member is mounted to the display; a first end of the resilient member is secured to the mounting member, and a second end of the resilient member is secured to the mounting member;
and the latching member is resiliently engaged with the installation shaft.

17. The electronic device of claim 16, wherein the display comprise a cover and a screen secured to the cover; the screen comprises a screen panel; the mounting member is secured to the screen panel; the cover comprises a pivoting portion, and the pivoting portion defines a pivoting slot; and the installation shaft is received in the pivoting slot.

18. The electronic device of claim 16, wherein the installation shaft comprises a plurality of side surfaces, and a corner is defined by each adjacent two of the side surfaces; and the latching member defines a recessed slot configured for latching the corner.

19. The electronic device of claim 18, wherein when the display is rotated from the initial portion to the second position, the corner is engaged in the recessed slot one by one.

20. The electronic device of claim 11, wherein a cross section of the rotating member is pear-shaped.
